(19) United States
(12) Patent Application Publication
(10) Pub. No.: US 2014/0090528 A1
(43) Pub. Date: Apr. 3, 2014

(54) METHOD AND DEVICE FOR TRANSPORTING A FIBER CONTOUR CUT OUT FROM A PLANAR WOVEN FABRIC IN THE COURSE OF PRODUCING FIBER-REINFORCED PLASTIC MOLDED PARTS

(71) Applicant: Matthias Graf, Bretten (DE)

(72) Inventor: Matthias Graf, Bretten (DE)

(73) Assignee: Dieffenbacher GmbH Maschinen-und Anlagenbau

(21) Appl. No.: 14/114,419

(22) PCT Filed: May 19, 2012
(86) PCT No.: PCT/EP12/59315

§ 371 Date: Dec. 17, 2013

(30) Foreign Application Priority Data
May 19, 2011 (DE) 102011076152.7

(51) Int. Cl. B25J 15/06; B26D 7/18

(52) U.S. Cl. CPC B25J 15/0616; B26D 7/18
USPC 83/23; 294/188

(57) ABSTRACT

A method and a device for transporting a fiber contour cut out from a planar woven fabric for producing a preform by a vacuum gripper. The method comprises the following method steps: a) a fiber contour is cut out from the woven fabric on a cutting table, b) a vacuum gripper moves over the fiber contour and brings a surface of the transport plate in contact with the cut-out fiber contour and a holding plate in contact with the planar woven fabric, c) the fiber contour is fastened to the transport plate by a vacuum device and through-holes in the transport plate and is lifted from the cutting table, while the holding plate fastens the woven fabric to the cutting table, d) after the transport plate is lifted, the vacuum gripper and/or the holding plate is/are lifted from the cutting table and the fiber contour is transported by the vacuum gripper.

The invention relates to a method for transporting a fiber contour cut out from a planar woven fabric in the course of producing fiber-reinforced plastic molded parts according to the preamble of claim 1 and a device according to the preamble of claim 4.

In the course of producing fiber-reinforced plastic components, which are also known as fiber composite components, the RTM method (resin transfer molding method), is commonly used especially in industrial applications. The entire production process up to a useful plastic component consists of several individual processes occurring successively. Preforms/prepregs are produced in a first method step. In this preform process, multilayer fabrics or fiber structures are usually joined in 2D (two-dimensional), i.e. substantially in one plane, so that the preform substantially already has the necessary outer contours and partly also already special and/or multiple layers or layer thicknesses. Preferably, a binder is introduced into the separating planes or the structure per se, which after its activation and/or curing leads to a fixing of the layers with respect to each other and therefore to the determination of a fixed 3D form, which is formed in the further progress of the preform process in a forming tool (shaping die, draping tool or the like). The preform is subsequently cut or punched out as required at predetermined points in order to obtain an even more precise contour. After inserting the preform into the press mold, the halves of the mold are closed and the necessary resin is injected into the cavity of the mold, wherein the resin impregnates the fiber structure of the preform, encloses the fibers and tightly binds them into the matrix. The fiber-reinforced plastic component can then be removed from the mold after curing of the resin.

In addition to the RTM process itself, the production of a preform already lays the foundation for the success of the production of a plastic component. The goal is to obtain a preform after the shaping of the preform from a limp material which is sufficiently rigid in order to be placed in a completely automatic and operationally reliable manner into the mold of an RTM press, or also to be transported and stacked for further use. There are a large number of possibilities in the relevant state of the art for producing, shaping and fixing the preform.

The following method steps are known for 3D forming of multilayer two-dimensional cutouts from woven fabrics: woven fabrics or structures are wound off from a roller and placed together from several different fabrics or structures, shapes and sizes into a woven fabric stack, as required. It may be necessary to process or cut the outside contour and optionally the inside contour according to a cutting pattern of the preform or shaped plastic part. The cutting pattern is produced from a developed view of the preform or the end component. Preferably, the produced woven fabric stack which is substantially flat will be draped by means of a draping device, or formed into a three-dimensional preform. In order to obtain a substantially rigid preform from a limp woven fabric, it is mostly necessary that a binder is introduced between the individual layers and is subsequently cured.

It has been noticed that even minute faults or damage or impressions on or in the woven fabrics can lead to visible defects in the future plastic shaped parts. For this reason it is essential that during the production of a preform from several layers, wherein at least one layer is a fiber structure, said fiber structure is treated with care. The cutting or punching of a contour is usually harmless and is performed in various manners. For example, a contour can be cut out on a cutting table by means of a rotary fabric cutter from a roll of woven fabric. Subsequently, a lifting device moves over the cut contour and lifts the contour (the cut woven fabric or structure) and moves the same to a draping mold. This step can also be performed several times in order to produce a multilayer preform. A gluing station can be passed during or in the course of the method depending on the embodiment which accordingly provides contour with the binder.

A suction gripper that has proven its worth in the meantime and is especially based on the Bernoulli principle is known from a large number of publications, e.g. from DE 10 2008 023 907 A1, DE 10 2008 062 343 A1 or DE 103 47 545 A1. It is a common feature in all these suction grippers that the operation is not performed with vacuum but with compressed air, and a workpiece (in the present case a limp woven fabric or contour) can be lifted. It is understood that these suction grippers are connected to respective manipulators (three-axis moving device, industrial robot or the like) with an interface.

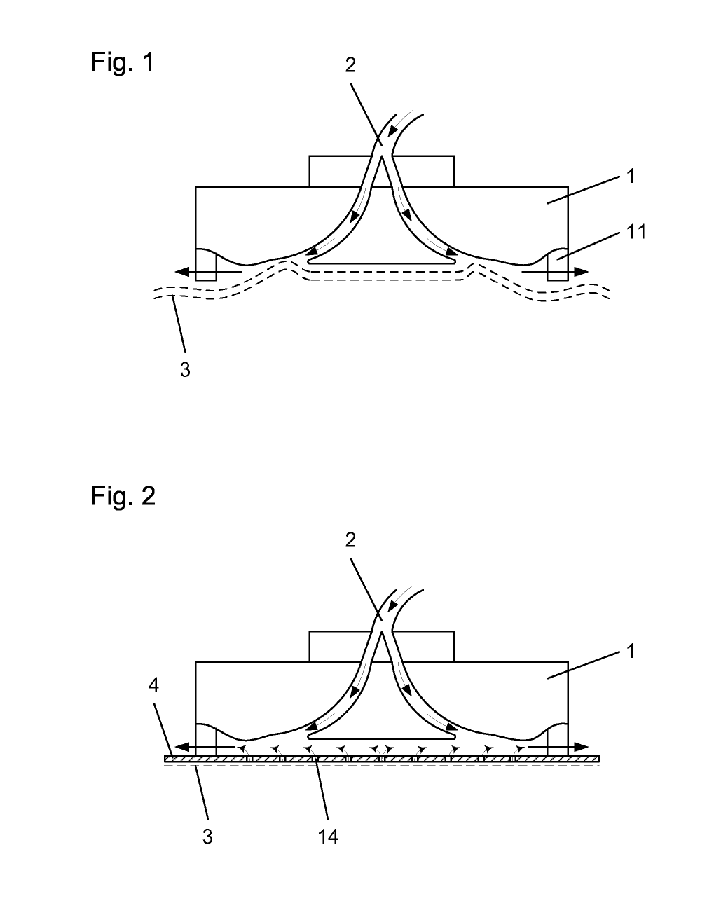

It is disadvantageous in this kind of suction grippers that they still leave impressions on the woven fabrics to be lifted, as is shown in a slightly exaggerated manner in FIG. 1 in respect of the state of the art. The contour is drawn into the flow space necessary for the Bernoulli effect by the incoming compressed air and the resulting Bernoulli effect. This leads to displacements of the fiber structure or threads within the fiber structure, which may certainly be recognizable in the future plastic shaped part. It has also been noticed that especially the circular external shape of the suction gripper also leaves a mostly circular impression on the woven fabric.

It was noticed at the same time that most cutting devices are not always 100% successful in severing woven fabric on the cutting table. It may also occur that the woven fabric is damaged not only during the fixing and lifting of the fiber structure by the suction gripper but also by residual connections which draw on the cut contour during lifting and warp the woven fabric of the contour, and that further the woven fabric is damaged in this way or even displaced, which again leads to problems in the next following cutting process for the next contour. In addition to erroneous cuts, defective contour shapes can also occur when folds are formed, thereby producing a defective preform.

It is the object of the invention to provide a method and device with which a contour that has been cut out can securely be lifted and displaced in a simple and secure manner as compared to the state of the art, wherein cutting errors on the contour of the woven fabric have no effects on the further production process and the woven fabric is not damaged during pickup and transportation. Furthermore, it shall advantageously be prevented that the fiber structure remaining on the cutting table is damaged by the removal of the contour and/or is subjected to changes in its position, thereby preventing errors in contours to be cut subsequently in a sufficiently secure way.

The term of fiber contour for a fiber structure to be cut out and to be manipulated will be used below. The term of contour relates below to the external shape of the woven fabric that has been cut out and accordingly also to the external shape of the support and/or retaining plate. The entire structure concerning fixing and lifting shall refer to the suction gripper, wherein the suction device could also be present in a larger number in the suction gripper, according to the predetermined fiber contour.

This object is achieved by the method in such a way that a fiber contour is cut out on a cutting table from a flat woven fabric by means of a cutting device by forming a separating cut, and subsequently a suction gripper moves over the fiber contour and brings a surface of the transport plate in contact with the cut-out fiber contour and a retaining plate in contact with the flat woven fabric, and wherein the fiber contour is fastened to the transport plate by means of suction devices arranged on the second surface side of the transport plate and through-holes in the transport plate which correspond to the suction devices and is lifted from the cutting table, while the retaining plate fixes the woven fabric to the cutting table, and wherein the suction gripper and/or the retaining plate is/are lifted from the cutting table after the lifting of the transport plate and the fiber contour is transported by the suction gripper.

The object is achieved by a device in such a way that at least one suction device is arranged on a suction gripper on a first surface side of a transport plate, wherein the second surface side is suitable for the suction of a fiber contour through the through-holes in the transport plate which correspond to the suction device, and the transport plate is substantially arranged in its external contour like the cut-out fiber contour, wherein the retaining plate, when arranged in one plane with the transport plate, encloses said transport plate substantially by forming a gap, and wherein the retaining plate and/or the transport plate is displaceable by means of at least one suitable actuating device in at least two planes which differ from one another.

Furthermore, this leads to advantages in that the fiber contour can be transported in a careful manner and any potential residual connections in the separating cut can be severed by means of retaining without significantly distorting the woven fabric or the fiber contour.

It is further advantageous if the suction devices operate according to the Bernoulli principle and the air flows of the suction devices produced by the supply of compressed air are substantially guided away from the separating cut of the fiber contour or the woven fabric through the transport plate and the retaining plate without causing any swirling on the separating cuts. It is further advantageous that the fiber contour is spread out in a flat manner in the course of making contact with the transport plate and may thus be placed in a better way on a scrim for a preform or is better suitable for gluing. It can further be provided to have the fiber contour resting in a flat manner on the transport plate monitored with automatic imaging or other suitable monitoring devices during transport in order to determine whether the quality is sufficient further processing.

It is obvious that the suction device can also be operated with negative pressure, but preferably with compressed air.

The device is especially suitable for performing the method, but can also be operated independently.

It is now advantageously prevented that damage on the fiber structure remaining on the cutting table and on the fiber contour to be lifted will occur, because during the lifting a retaining plate close to the contour or corresponding to the contour will press the remaining woven fabric onto the base or the cutting table. As a result, damage on the fiber contour to be lifted is also prevented and the fiber contour is substantially held in one plane on the transport plate and in the suction gripper by the suction devices. It is further advantageous that the retainer prevents that the remaining woven fabric on the cutting table is lifted or swirled by the suction apparatuses or their air flows beyond the transport plate. It is further prevented in a similarly advantageous manner as a result of the configuration of the transport plate which is close to the contour according to the cut-out fiber contour that the air flows of the suction apparatuses will fray the lifted fiber contour at its edges on the separating cut. The same also applies to the remaining woven fabric on the cutting table, which is especially advantageous in an optimized cutting arrangement of the contours when a separating cut forms the edge of two different fiber contours for example, wherein they are to be lifted successively.

By using a suction apparatus operated by compressed air, air is drawn to the surface side of the suction devices through the through-holes in the transport plate, which substantially occurs according to the Bernoulli-Venturi principle. The through-holes can be suitable holes or oblong holes, whose arrangement or size can be determined by tests and may depend among other things on the type of the woven fabric, the strength of the air flows and other factors.

Further advantageous measures and embodiments of the subject matter of the invention are provided in the dependent claims and are described in the description with the drawings below, wherein:

FIG. 1 shows a sectional view of a conventional suction device according to the state of the art when receiving a limp fabric;

FIG. 2 shows a further sectional view of a suction device in accordance with the invention with a transport plate during the accommodation of a limp fabric;

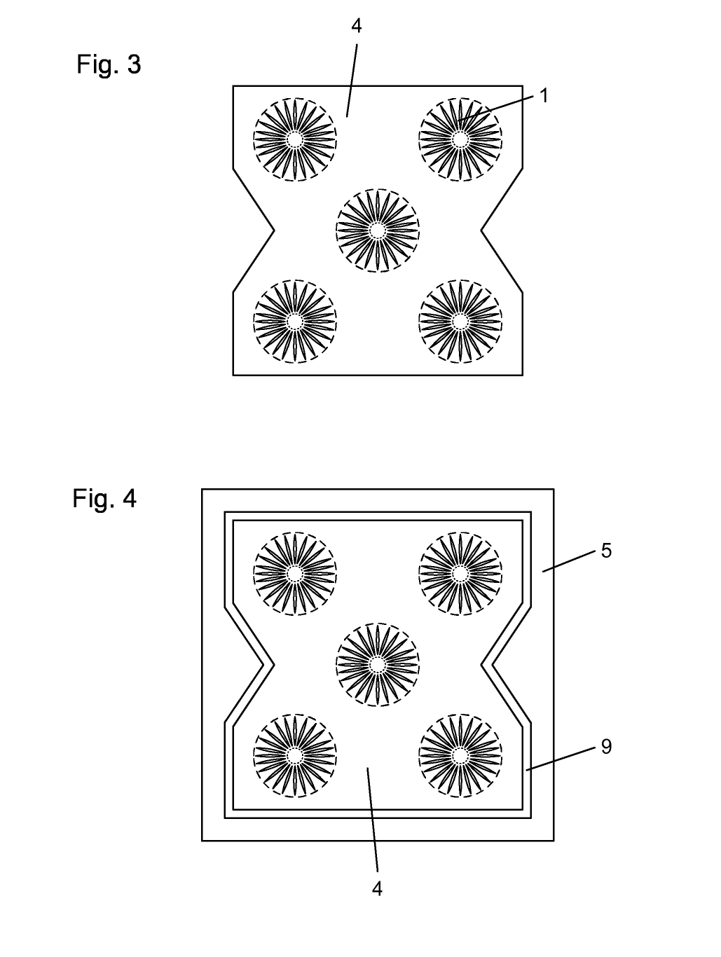

FIG. 3 shows a sectional top view of a contour of a transport plate with suction devices arranged thereon;

FIG. 4 shows a further sectional top view of a contour of a transport plate with suction devices according to FIG. 3 which are arranged thereon, with additional illustration of a corresponding retaining plate and a gap arranged in between;

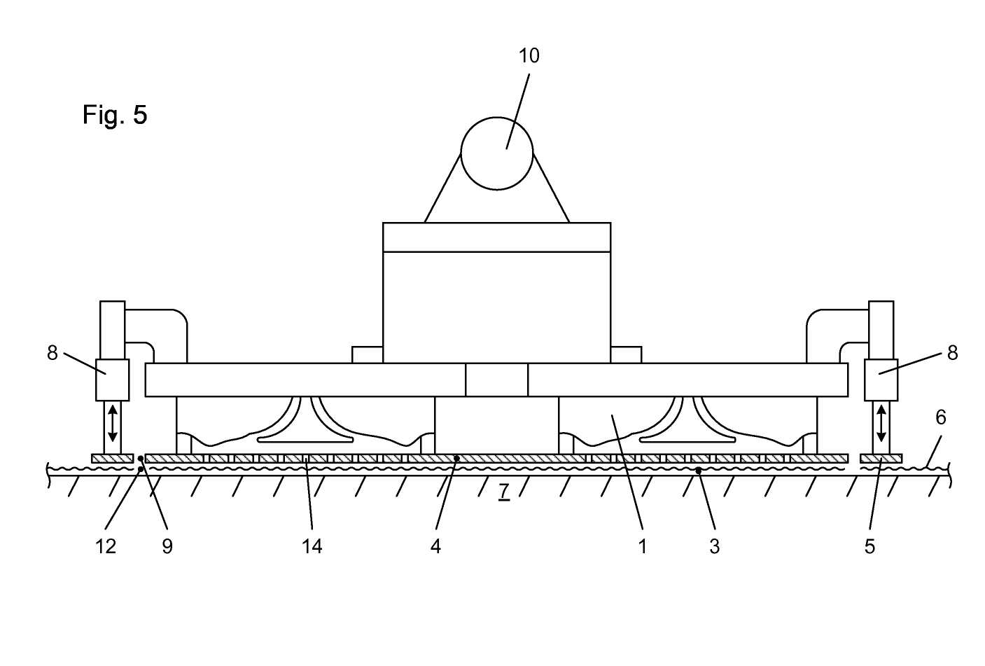

FIG. 5 shows an enlarged view of a lifting apparatus according to FIG. 3 in a lateral sectional view with additional illustration of the actuating devices for the retaining plate.

FIG. 1 shows a sectional view of a conventional suction device according to the state of the art when receiving a limp fabric, which deforms under the Bernoulli effect and is drawn into the necessary cavities for the suction device 1. The illustration also clearly shows that the support bodies 11 are arranged on the outer circumference of the suction device 1 and are capable of leaving impressions on the fiber contour 3. The air flows of the compressed air supply 2 symbolized by the arrows.

FIG. 2 shows how the flat transport plate 4, which clearly protrudes beyond the outer contour of the suction device 1, prevents that the sensitive fiber contour 3 will deform. In order to still allow the effect of the suction device 1 to act on the fiber contour 3, boreholes, oblong holes or other suitable through-holes 14 are provided in the transport plate 4, which are arranged in a corresponding manner to the suction device 1 so that the passing air flow produces a kind of Venturi effect in the through holes 14, thereby producing the adherence of the fiber contour to the transport plate 4.

FIG. 3 shows a sectional top view of a contour of a transport plate 4 with suction devices 1 arranged thereon. As a result of the transport plate 4, the fiber contour 3 which is situated beneath is substantially covered, wherein no through-holes 14 can be recognized, but which shall not exclude the potential arrangement thereof outside of the contact points of the suction devices 1 with the transport plate 4.

FIG. 4 shows a further sectional top view of a contour of a transport plate 4 with suction devices 1 according to FIG. 3 which are arranged thereon, including an additional illustration of a corresponding retaining plate 5 and a gap 9 which is formed in between. Preferably, the gap 9 substantially emulates the contour of the fiber contour 3, so that when compressed air exits from the suction devices the separating cuts 12 between the fiber contour 3 and the woven fabric 6 cannot be attacked by the air flows.

FIG. 5 shows an enlarged view of a lifting device or a suction gripper according to FIG. 3 in a lateral sectional view with additional illustration of the exemplary actuating apparatuses 8 for the retaining plate 5. In the present view, the fiber contour 3 is fixed by the transport plate 4 and the region of the woven fabric 6 adjacent to the separating cuts 12 is fixed with the retaining plate 5 to the cutting table 7.

### LIST OF REFERENCE NUMERALS: DP 1422

1 Suction device

2 Compressed air supply

3 Fiber contour

4 Transport plate

5 Retaining plate

6 Woven fabric

7 Cutting table

8 Actuating apparatus

9 Gap

10 Interface

11 Support body

12 Separating cut

13

14 Through-holes

1. A method for transporting a fiber contour cut out from a planar woven fabric in the course of producing a single-layer or multilayer preform as a pre-stage for producing fiber-reinforced plastic molded parts with a suction gripper, characterized by the following method steps:
1.1 a fiber contour is cut out on a cutting table from a planar woven fabric by means of a cutting device by forming a separating cut;
1.2 a suction gripper moves over the fiber contour and brings a surface side of the transport plate into contact with the cut-out fiber contour and a retaining plate into contact with the planar woven fabric;
1.3 the fiber contour is fixed to the transport plate by means of suction devices arranged on the second surface side of the transport plate and through-holes in the transport plate which correspond to the suction devices, and is lifted from the cutting table while the retaining plate fixes the woven fabric to the cutting table;
1.4 after the lifting of the transport plate the suction gripper and/or the retaining plate will lift from the cutting table and the fiber contour is transported by the suction gripper.

2. A method according to claim 1, characterized in that the suction devices operate according to the Bernoulli principle and the air flows of the suction devices produced by the compressed air supply are guided through the transport plate and the retaining plate substantially away from the separating cut of the fiber contour.

3. A method according to claim 1, characterized in that the fiber contour is spread in a flat manner in the course of establishing contact with the transport plate.

4. A device for transporting a fiber contour cut out from a planar woven fabric in the course of producing a single-layer or multilayer preform as a pre-stage for producing fiber-reinforced plastic molded parts with a suction gripper which can be moved multi-axially by a suitable device, wherein at least one suction device is arranged on the suction gripper on a first surface side of a transport plate, wherein the second surface side is suitable for suction of a fiber contour by through-holes in the transport plate which correspond to the suction device, and the transport plate is arranged substantially in its outer contour like the cut fiber contour, wherein in an arrangement in a plane with the transport plate the retaining plate substantially encloses said transport plate by forming a gap, and wherein the retaining plate and/or the transport plate is movable by at least one suitable actuating device into at least two mutually different planes.

5. A device according to claim 4, characterized in that the suction device can be operated with negative pressure or compressed air.

6. A device according to claim 4, characterized by the use of the device for carrying out the method.
